(19) United States
(12) Patent Application Publication
(10) Pub. No.: US 2014/0183070 A1
(43) Pub. Date: Jul. 3, 2014

(54) Device for Disposing Medicament Products

(71) Applicant: QRxPharma Ltd., North Sydney, NSW (AU)

(72) Inventors: John W. Holaday, Bethesda, MD (US); Edward M. Rudnic, Potomac, MD (US); Beth A. Burnside, Bethesda, MD (US); Donald Treacy, Woodbine, MD (US); Marcus Schestopol, Chevy Chase, MD (US); Kristin Benokraitis, Durham, NC (US); Ed Browka, Oneida, NY (US); Jessie Delgado, Durham, NC (US); David Foshee, Apex, NC (US)

(73) Assignee: QRxPharma Ltd., North Sydney NSW (AU)

(21) Appl. No.: 13/958,368

(22) Filed: Aug. 2, 2013

Related U.S. Application Data
(60) Provisional application No. 61/746,567, filed on Dec. 28, 2012.
(60) Provisional application No. 61/805,504, filed on Mar. 26, 2013.

(51) Int. Cl. B09B 3/00

(52) U.S. Cl. CPC B09B 3/0075
USPC 206/221

(57) ABSTRACT

A device for the neutralization and disposal of unused medicaments, such as drugs or medications. The device generally comprises a means of storing disposal device material, which can render medicaments unusable, and a means of exposing the disposal device material to the medicaments when they are no longer in use. The device may be a medicament container comprising a reservoir to store the disposal device material, and a means to expose the disposal device material to the medicaments. Alternatively, the device may be a medicament closure or lid for use with a medicament container, in which the closure comprises a reservoir for storing the disposal device material and a means to expose the disposal device material to the medicaments.

### CROSS REFERENCE TO RELATED APPLICATIONS

This application claims priority to U.S. provisional application Ser. No. 61/746,567 filed on Dec. 28, 2012, and to U.S. provisional application Ser. No. 61/805,504 filed on Mar. 26, 2013. Each of these applications is incorporated herein by reference.

### FIELD OF THE INVENTION

The present invention relates to a device for the neutralization and disposal of unused medicaments, such as drugs or medications. The device of the present invention generally comprises a means of storing disposal device material, which can render medicaments unusable, and a means of exposing the disposal device material to the medicaments when they are no longer in use. In certain aspects of the invention, the device comprises a medicament container comprising a reservoir to store the disposal device material, and a means to expose the disposal device material to the medicaments. In other aspects of the invention, the device comprises a closure or lid for use with a medicament container, in which the closure comprises a reservoir for storing the disposal device material and a means to expose the disposal device material to the medicaments.

### BACKGROUND OF THE INVENTION

Many medicaments, such as pharmaceutical drugs that are psychoactive or analgesic, have significant ability to cause euphoria or pleasurable effects, and are thereby at risk for abuse. In many instances where abuse occurs, the drugs are crushed, melted, dissolved or altered, and are then inhaled, snorted, injected or swallowed in a manner or dosage that is inconsistent with their intended or safe use. Tampering of immediate release formulations, or extended release formulations in particular, will rapidly deliver to the abuser a massive dose and produce a variety of serious and life threatening side effects, including respiratory depression and failure, sedation, cardiovascular collapse, coma, and death. Likewise, there are a number of medicaments that, when administered at any level, cause undesirable side effects, such as chemotherapeutics. Other medicaments such as antibiotics can accumulate in the environment and may increase the evolution of antibiotic resistant organisms when disposed of by such means as leaving them in the garbage or flushing them in a toilet. It is important to dispose of such unused medication properly to prevent wrongful administration or contamination of waste-water treatment facilities.

Therefore, there is a need for a convenient and widely distributed or easily obtainable means to safely and effectively dispose of medicaments that are no longer needed by the patient to whom the product was intended or prescribed.

### SUMMARY OF THE INVENTION

The present invention relate to a device for the disposal and/or neutralization of medicaments. The disposal device generally comprises a means to store disposal device material that can neutralize or render medicaments unusable, and a means to expose the disposal device material to the medicaments.

In certain aspects of the invention, the device comprises a cylindrical container comprising walls, an open end, and a closed end located opposite to the open end, in which (a) the closed end comprises a reservoir that is separated from the inside of the cylindrical container by a barrier that traverses the cross-section of the cylindrical container, wherein the reservoir is enclosed by the barrier and a circular disc located opposite to the barrier that traverses the cross-section of the cylindrical container; (b) the barrier comprises a removable portion; (c) the circular disc comprises an oblong component that extends into the reservoir; and (d) the circular disc is movable and is positioned such that manual pressure on the circular disc in a direction towards the barrier places the oblong component in contact with the removable portion of the barrier. The reservoir may comprise a volume for housing a deactivating material in the form of powder, pellets, beads, beadlets, liquid, or granules.

In some embodiments, the circular disc or a portion thereof may be positioned such that pressure on the circular disc in a direction towards the barrier places the oblong component in contact with the removable portion of the barrier. In particular, the circular disc or a portion thereof may be positioned such that pressure on the circular disc in a direction towards the barrier displaces the removable portion from the barrier.

In certain embodiments, the oblong component may comprise an end having a shape that fits into the surface of the removable portion of the barrier. The oblong component may also comprise a multitude of ribs. In some embodiments, the oblong component may be molded as part of the circular disc.

In further embodiments, the removable portion of the barrier is divided into two or more segments. The removable portion may comprise a flexible thinned region that acts as a living hinge to allow the segments of the removable section to move while remaining attached to the barrier. On the other hand, the segments of the removable portion may separate and become displaced from the barrier.

In some embodiments, the device may further comprise a removable seal positioned under the circular disc. The removable seal may comprise an annular thin section.

In some aspects of the invention, the device comprises a closure for a container, in which the closure comprises (a) a base comprising a cylindrical structure with a first end and a second end, wherein both the first end and the second end can fasten onto the container; and (b) a chamber comprising a cylindrical structure with a closed end, an open end, and surface walls extending there between. The chamber may be located inside of the cylindrical structure of the base, and at least a portion of the surface walls of the chamber is attached to the cylindrical structure. The open end of the chamber may comprise a removable plug. A structure in the chamber may extend from the closed end of the chamber to the removable plug and is positioned such that manual pressure on the closed end towards the removable plug causes the removable portion to move in a direction away from the closed end. Further, the first end of the base may be adjacent to the closed end of the chamber, and the second end of the base may be adjacent to the open end of the chamber.

In additional aspects of the invention, the device may comprise a closure for a container comprising (a) a base comprising a cylindrical structure with a first end and a second end and walls therebetween, wherein both the first end and the second end can fasten onto the container; (b) a chamber comprising a cylindrical structure with a closed end, an open end, and surface walls extending therebetween; and (c) a means of displacing the removable plug from the open end of the chamber, wherein the means comprises a first aspect that is adjacent to the wall of the base and a second aspect that is attached to the removable plug of the open end. The chamber may be located inside of the cylindrical structure of the base, and at least a portion of the surface walls of the chamber is attached to the cylindrical structure. Also, the first end of the base may be adjacent to the closed end of the chamber, and the second end of the base may be adjacent to the open end of the chamber. In some embodiments, fastening the second end of the base to the container causes the means of displacing the removable plug from the open end of the chamber to displace the removable plug. Also, fastening the second end of the base to the container may cause the first aspect of the means of displacing the removable plug from the open end of the chamber to displace in the opposite direction of the displacement of the removable plug. In certain embodiments, the means of displacing the removable plug from the open end of the chamber may comprise an arm array, in which the arm array comprises two or more arms radiating from a center, and the arms extend to the wall of the base and the center is attached to the removable plug. Alternatively, the means of displacing the removable plug from the open end of the chamber may comprise a lever, in which the lever comprises a first end and a second end, and wherein the first end of the lever is adjacent to the wall of the base and the second end of the lever is attached to the removable plug.

In some embodiments, the first end and the second end of the base may comprise one or more annular grooves. The first end of the base may also comprise a child-resistant lock, and/or the second end of the base may be irremovably fastenable to the container.

In certain embodiments, the chamber may further comprise a reservoir for housing a material in the form of powder, pellets, beads, beadlets, liquid or granules.

In addition, the removable plug may be displaceable fully from the open end of the chamber. In further embodiments, the device may comprise a removable seal adjacent to the open end of the chamber.

### BRIEF DESCRIPTION OF THE FIGURES

For a more complete understanding of the invention, reference is made to the following description and accompanying drawings, as follows:

FIG. 1 is a side view of a container with a closure according to embodiments of the invention.

FIG. 2 is an exploded perspective top view of a container according to embodiments of the invention.

FIGS. 3(a)-(b) are side views of (a) an assembled container according to embodiments of the invention, and (b) a cross-sectional side view of the container of (a) taken along the line shown in (a).

FIG. 4 is a magnified view of the area encircled in FIG. 3(b) according to embodiments of the invention.

FIG. 5 is a perspective top view of a medicament container according to embodiments of the invention.

FIGS. 6(a)-(b) are side views of (a) a closure in orientation 1 according to embodiments of the invention, (b) a closure fastened to a container in orientation 1 according to embodiments of the invention.

FIGS. 7(a)-(b) are side views of (a) a closure in orientation 2 according to embodiments of the invention, (b) a closure of the present invention fastened to a container in orientation 2 according to embodiments of the invention.

FIG. 8 is an exploded perspective bottom view of a closure in orientation 2 according to embodiments of the invention.

FIG. 9 is a perspective top view of a base in orientation 1 according to embodiments of the invention.

FIGS. 10(a)-(b) are side views of (a) a closure fastened to a container according to embodiments of the invention, and (b) a cross-sectional side view of the closure of (a) taken along the line shown in (a).

FIG. 11 is a magnified view of the area encircled in FIG. 10(b) according to embodiments of the invention.

FIGS. 12(a)-(b) are side views of (a) a closure fastened to a container according to embodiments of the invention, and (b) a cross-sectional side view of the closure of (a) taken along the line shown in (a).

FIG. 13 is an exploded perspective top view of a closure according to embodiments of the invention.

FIGS. 14(a)-(b) are side views of (a) a closure in orientation 1 according to embodiments of the invention, (b) a closure of the present invention fastened to a container in orientation 1 according to embodiments of the invention.

FIGS. 15(a)-(b) are side views of (a) a closure in orientation 2 according to embodiments of the invention, (b) a closure fastened to a container in orientation 2 according to embodiments of the invention.

FIG. 16 is an exploded perspective top view of a closure in orientation 2 according to embodiments of the invention.

FIG. 17 is a perspective top view of a base in orientation 1 according to embodiments of the invention.

FIGS. 18(a)-(b) are side views of (a) a closure fastened to a container according to embodiments of the invention, and (b) a cross-sectional side view of the closure of (a) taken along the line shown in (a).

FIG. 19 is a magnified view of the area encircled in FIG. 18(b) according to embodiments of the invention.

FIGS. 20(a)-(b) are side views of (a) a closure fastened to a container according to embodiments of the invention, and (b) a cross-sectional side view of the closure of (a) taken along the line shown in (a).

FIG. 21 is a magnified view of the area encircled in FIG. 20(b) according to embodiments of the invention.

### DETAILED DESCRIPTION OF THE INVENTION

The present invention relates to a device for the disposal and/or neutralization of unused human or animal medicaments, which includes pharmaceutical products such as prescription drugs and over-the-counter (OTC) drugs. The device may be used to deter abuse or misuse of medicaments by a person other than the intended recipient, to remove and/or render unavailable the active agent(s) from medicaments that have a high rate of abuse, and/or to limit and/or prevent release of medicaments into the environment.

The device of the present invention generally comprises a means to store disposal device material and a means to expose the disposal device material to the medicaments. The disposal device material may render a medicament unusable according to the use instructions and/or unavailable for extraction for abuse and/or unavailable for leaching into water supplies or landfills. The disposal device material, when combined with a solvent and the medicament, may form a gel or mass, i.e., a substance of high viscosity so that it is not easily pourable, transferable, mixable or vaporizable, and generally remains in the container in which the gel/mass is formed, such that the medicament is no longer useable for administration as directed in the use information, cannot be misused or accidentally used, or subject to abuse. As a result, the gel/mass will deter use of the medicament by an individual for whom the medicament was not intended, such as prevent an abuser from modifying the product to be used in a manner that is not consistent with the prescribing information or instructions for use. The disposal device material can be in the form of powder, pellets, beads, beadlets, liquid or granules. Examples of disposal device materials are set forth in U.S. provisional application Ser. Nos. 61/746,567 and 61/805,504, which are incorporated herein by reference.

In certain aspects of the invention, the device comprises a medicament container. In other aspects of the invention, the device comprises a closure to a medicament container.

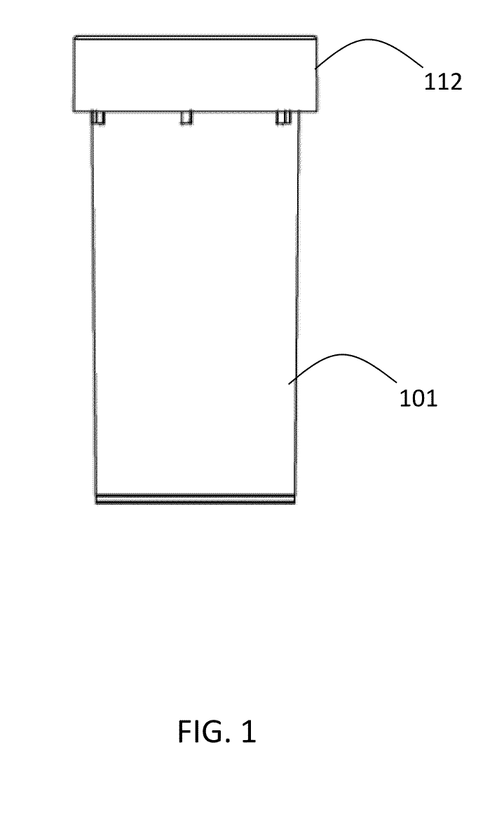

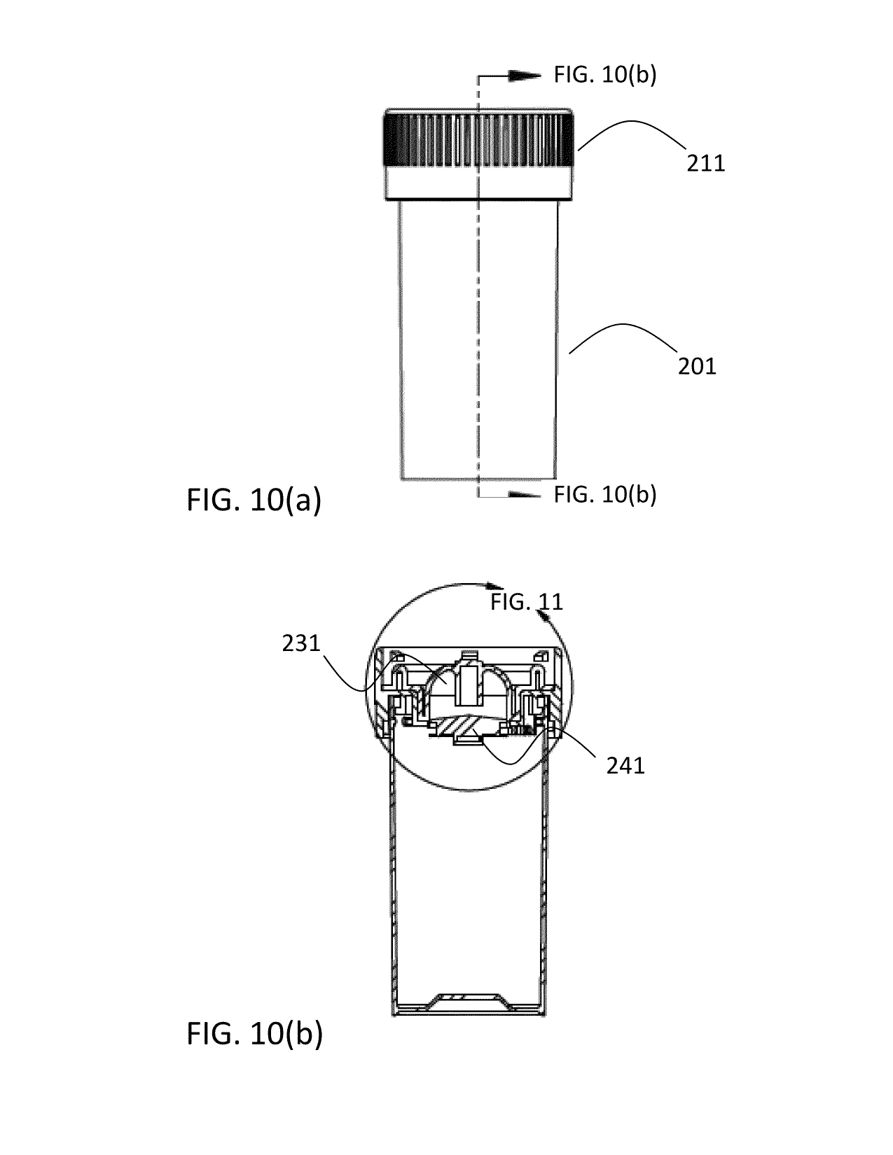

Embodiments of the medicament containers and the closures of the invention are illustrated in FIGS. 1-21; however, while the medicament containers and the closures will be described in conjunction with these embodiments, one of ordinary skill in the art can understand that these embodiments are not intended to limit the invention, and can recognize that the medicament containers and closures of the invention cover alternatives, modifications, and equivalents that may be included within the spirits and scope of the invention.

Medicament Container

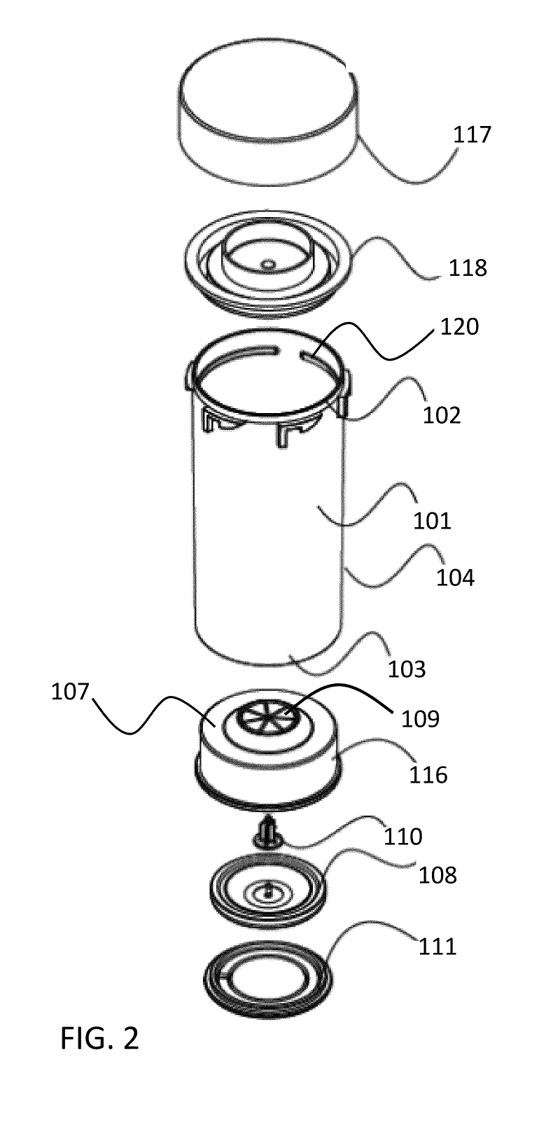

Aspects of the invention in which the device comprises a medicament container are exemplified in FIGS. 1-4. The medicament container 101 as shown in FIG. 1 can be cylindrical and used in conjunction with a closure 112 as known in the art. As shown in FIG. 2, container 101 comprises an open end 102, a closed end 103, walls 104, and an interior 106. Open end 102 can be covered with cap 112, which includes a seal 118 and an overcap 117. Cap 112 may include a child-resistant lock as known in the art (not shown). Adjacent to open end 102, container wall 104 may have ledges 120 on the inner surface of container 101 that allow cap 112 to engage with open end 102.

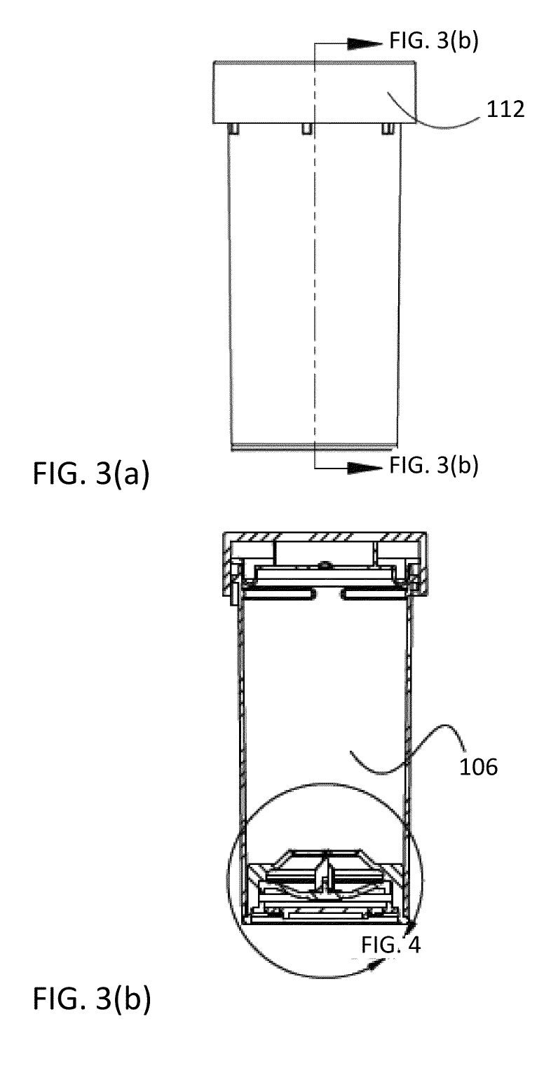

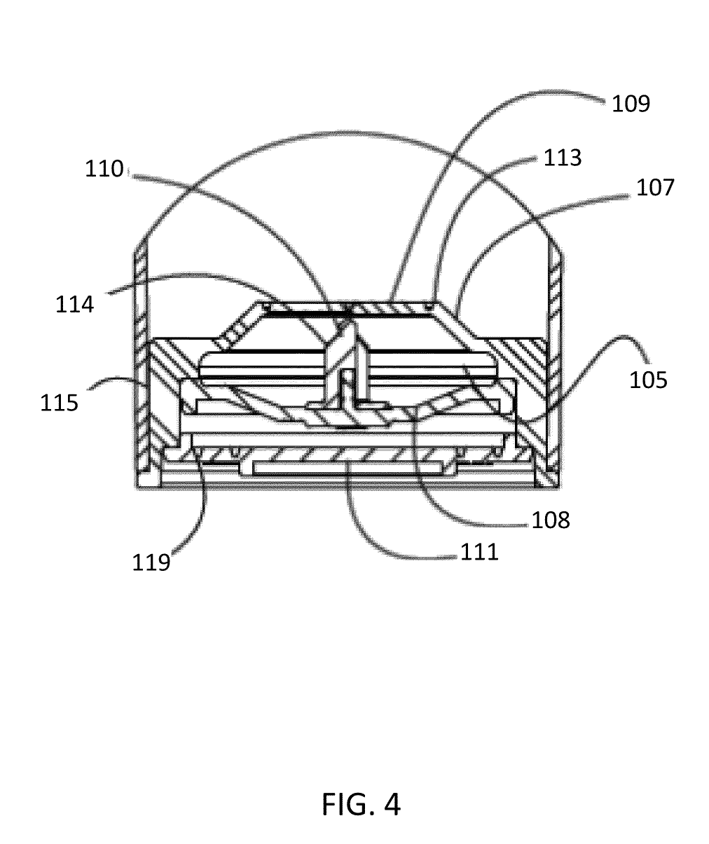

Closed end 103 of container 101 may comprise a dispensing unit 116 as shown in FIGS. 3(a) and 3(b). The structure of dispensing unit 116 is detailed in FIG. 4. Dispensing unit 116 may comprise a barrier 107 that traverses the cross-section of the cylindrical container 101, and a reservoir 105 located between the barrier 107 and disc 108. Reservoir 105 can be used to store the disposal device material.

Referring to FIGS. 2 and 4, barrier 107 may prevent the disposal device material in reservoir 105 from contacting the medicament. Barrier 107 may include a removable portion 109, which, in some embodiments, can be divided into several segments (not shown). The individual segments may be separated from each other by lines of weakness extending radially from the center of removable portion 109. In certain embodiments, the lines of weakness may have a lower thickness than the individual segments of removable portion 109. This thickness differential may allow removable portion 109 to rupture along the lines of weakness when force is applied to it, while leaving the individual segments intact and free to move in relation to each other and to container walls 104. In some embodiments, removable portion 109 may be bordered by a flexible thinned region 113 that acts as a living hinge. When removable portion 109 ruptures, the living hinge may allow the segments of removable portion 109 to move while the segments remain attached to barrier 107. In further embodiments, region 113 may be a line of weakness, such that when force is applied to section 119, removable portion 109 can detach from barrier 107.

A removable seal 111 may be positioned to prevent manual pressure from being applied to circular disc 108 without removing the removable seal. Circular disc 108 may be movable if manual pressure is applied to it in the absence of removable seal 111, e.g., after removable seal 111 is removed from container 101. In some embodiments, removable seal 111 may have an annular thin section that preferentially breaks so that the thin section can be removed. In certain embodiments, removable seal 111 comprises a tab that allows seal 111 to be manually removed from container 101. For example, the tab may be an extraction ring attached to the removable seal 111 that can be hooked by a finger for removal.

In certain embodiments, seal 111 is attached to frame 119, which is located between seal 111 and disc 108. Removal of seal 111 may also cause removal of frame 119 and exposure of disc 108.

Circular disc 108 may contain an oblong component 110 that extends into the reservoir 105. Disc 108 can be positioned such that manual pressure on it in a direction towards barrier 107 places oblong component 110 in contact with removable portion 109. In some embodiments, oblong component 110 may have an end having a shape that fits into the surface of removable portion 109. Oblong component 110 may be molded as part of disc 108 or as a separate part to allow for different material properties, for example, for disc 108 to serve as barrier to moisture and for oblong component 110 to be able to disrupt removable portion 109.

The configuration illustrated in FIGS. 2-5 facilitates isolation of the disposal device material inside reservoir 105. Circular disc 108 and barrier 107 may be configured to provide an airtight seal if required to protect ingredients contained within reservoir 105 from atmospheric moisture, air, or other ambient environment.

Sufficient manual pressure applied to circular disc 108 can cause the end of oblong component 110 to contact removable portion 109. The force applied on circular disc 108 can cause oblong component 110 to rupture removable portion 109 along the lines of weakness separating the segments of removable portion 109, thereby exposing the disposal device material in reservoir 105 to the interior 106 of container 101. In embodiments where region 113 is a living hinge, the segments of removable section can move inside container interior 106, while remaining attached to barrier 107. In embodiments where region 113 is a line of weakness, the segments of removable portion 109 may become completely detached from barrier 107.

In certain embodiments, oblong component 110 may have a multiple of ribs 114 that hold the segments of section 109 in a position that allows disposal device in reservoir 105 to flow. The number of ribs may be different than the number of segments of removable portion 109. The ribs can also be spaced such that one rib may align with a gap between individual segments of section 109 and allow them to collapse into their original position, while the remaining ribs will be positioned to hold the remaining segments open.

The container of the present invention can be used to render unusable any medicament remaining within the container once the patient has completed the course of therapy. In one embodiment, the medicament remaining within the container is in oral dosage form such as, but not limited to, a tablet, capsule, or other solid oral product. In certain embodiments, the medicament in the container may be rendered unusable by a method comprising (a) adding water to cylindrical container 101; (b) removing seal 111; (c) applying manual pressure on circular disc 108 to cause oblong component 110 to rupture removable portion 109 of barrier 107, thereby exposing interior 106 of container 101 to disposal device material from reservoir 105; (d) optionally shaking the contents of cylindrical container 101. The amount of water to be added in (a) will vary with the composition and amount of the material stored in reservoir 105 The interaction between the water and the disposal device material will cause a gel/solid mass to form inside container 101. This gel/solid mass will render the remaining medicament unusable. Once the gel/mass has formed, container 101 can be deposited in the household, industrial or other suitable waste container for disposal.

Container 101 may be of a size, shape, and material composition as those pharmacy vials known in the art. For example, sizes of pharmacy dispensing bottles may range from 30 ml to 100 ml. Similarly, closure 112 used with container 101 can be those known in the art.

Disposing unit 116, including the reservoir 105, can be scaled according to the pharmacy container size in anticipation of the volume of water to be added to the bottle. Disposing unit 116 can be manufactured by methods known to those skilled in the art, and be made from standard paper, waxed board like a milk carton, plastic, polymers, etc. or specialty materials that confer functionality and that are capable of holding both liquid and solid material. Examples include high-density polyethylene, polypropylene, and the like.

Medicament Container Closures

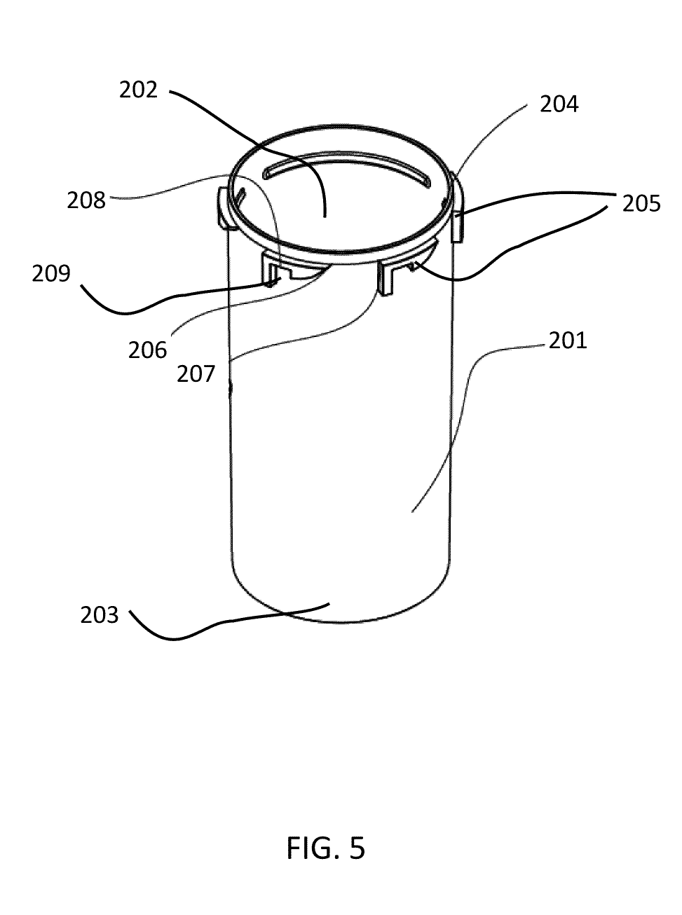

Aspects of the invention in which the device comprises a medicament container closures are exemplified in FIGS. 5-21. Closure 211, which comprises a first end 212 and a second end 213, can be used with medicament containers that are known in the art. An example of such a container is illustrated in FIG. 5. Container 201 may be in the general shape of a hollow cylinder comprising an open end 202 and a closed end 203. Adjacent to open end 202, container 201 may also comprise ledges 204 and fastening members 205. Fastening members 205 are used to engage the cap 211, and each fastening member 205 comprise an angled edge 206, a straight edge 207, a pocket edge 208 therebetween, and a pocket 209. Fastening members 205 can engage with child-resistant locks of medicament closures known in the art.

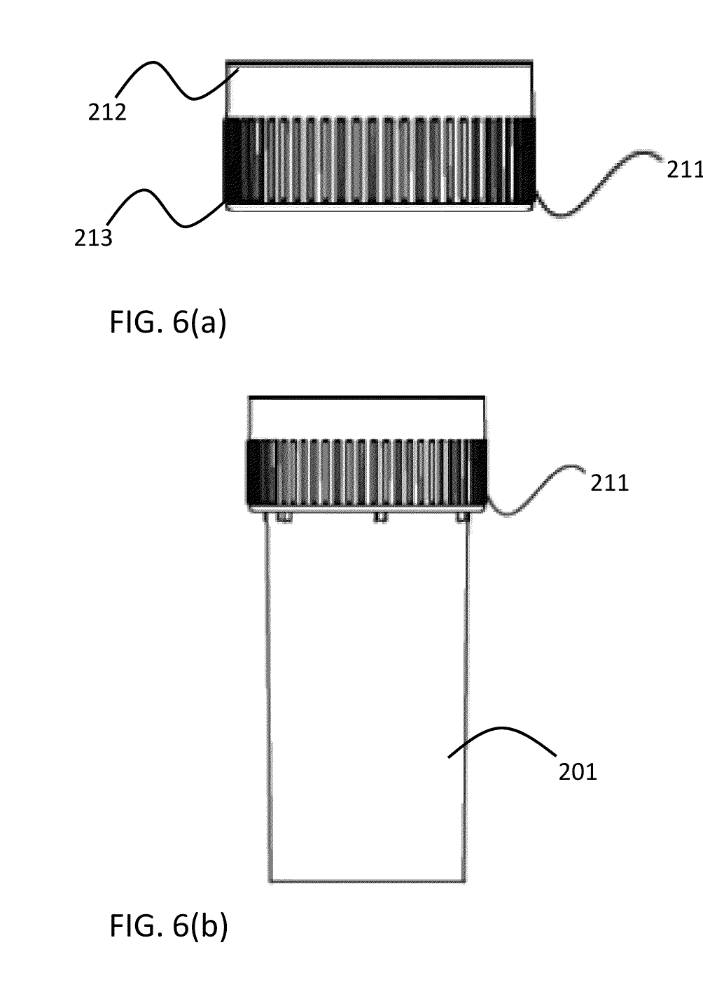

As shown in FIGS. 6(a)-(b) and 7(a)-(b), closure 211 can be fastened to container 201 in two orientations. Orientation 1, shown in FIGS. 6(a)-(b), is used to close container 201 while the medicament is still being administered according to its intended use, i.e., prior to disposing the medicament. In orientation 1, second end 213 of closure 211 is removably fastened to container 201. In some embodiments, second end 213 of closure 211 may comprise a child-resistant lock, as known in the art.

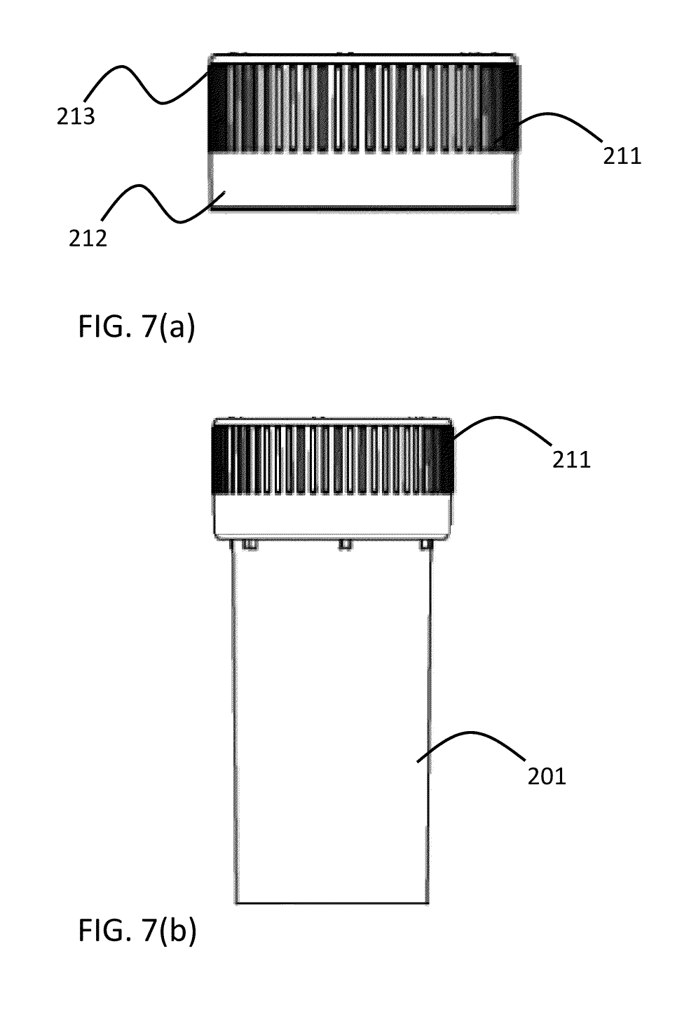

Orientation 2, as shown in FIGS. 7(a)-(b), is used to close the container for disposing of the medicaments. In orientation 2, first end 212 of closure 211 is irremovably fastened to container 201.

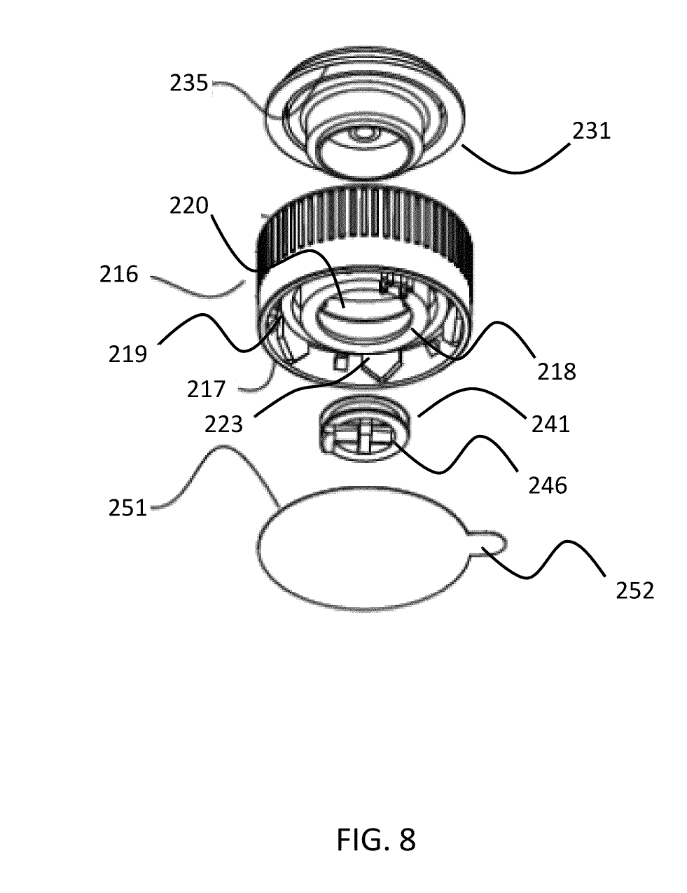

FIG. 8 shows an exploded view of closure 211 in orientation 2. Closure 211 may comprise a base 216, a chamber 231, a plug 241, and a removable seal 251. Base 216 may comprise an outer shell 217, an inner skirt 218, and one or more inner rims 219. In certain embodiments, outer shell 217, inner skirt 218, and one or more inner rims 219 are cylindrical and concentric. Inner skirt 218 may be a hollow cylinder with a lumen 220.

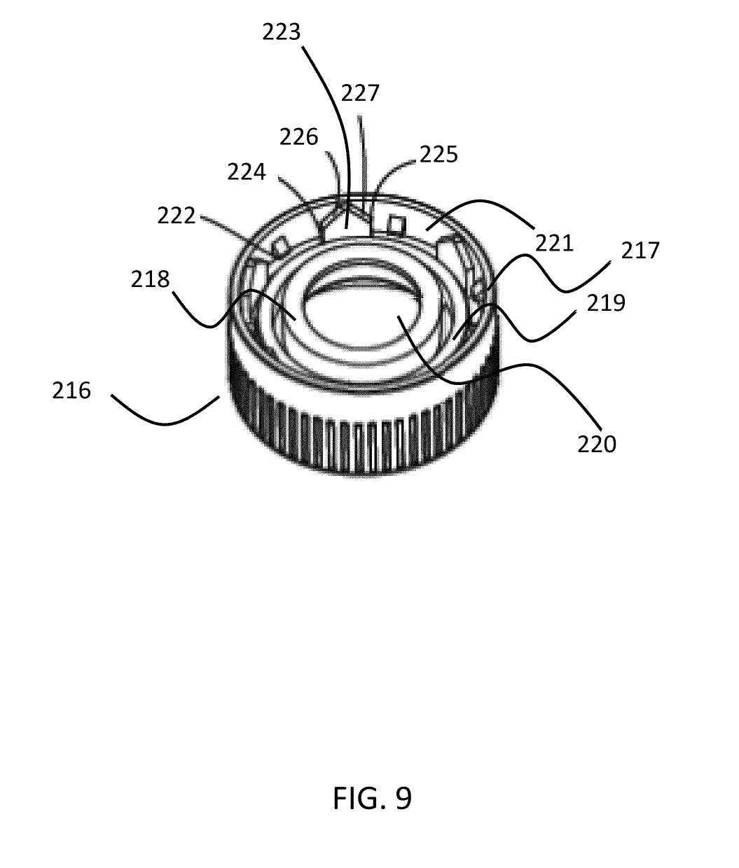

FIG. 9 depicts closure 211 in orientation 1 and shows the inner surface 221 of outer shell 217 that may have structures to enable closure 211 to be irremovably fastened to container 201 in orientation 2. These structures include one or more pawls 222 and one or more angled members 223. Angled members 223 may comprise one or more angled surfaces, and in some embodiments, may comprise two angled surfaces that meet at a corner. In certain embodiments, the angled members may resemble a hexagon with a first straight surface 224 and a second straight surface 225, and a first angled surface 226 and a second angled surface 227.

Closure 211 may be irremovably fastened to container 201 in orientation 2 due to the engagement of one or more pawls 222 and angled members 223 with fastening members 205 of container 201. Fastening closure 211 to container 201 is achieved by applying pressure on closure 211 towards open end 202 of container 201, or applying pressure of container 201 towards first end 212, or applying pressure of closure 211 and container 201 towards each other. During fastening, pawl 222 and angled member 223 are engaged with angled edge 206, pocket edge 208, and pocket 209 of a first fastening member 205, and straight edge 207 of an adjacent fastening member 205. Initially during fastening, first angled surface 226 and second angled surface 227 of angled member 223 are engaged with angled edge 206 of one fastening member 205 and straight edge 207 of an adjacent fastening member 205, respectively. Simultaneously, pawl 222 is aligned to slide over pocket edge 208 and into pocket 209 of the first fastening member 205. Once fastening is complete, pawl 222 is in pocket 209. First straight surface 224 and second straight surface 225 of angled member 223 are engaged with angled edge 206 of the first fastening member 205 and straight edge 207 of the adjacent fastening member 205, respectively, which prevents pawl 222 from rotating out of pocket 209. As a result, closure 211 is irremovably fastened to container 201. If there are more than one pawl 222 and angled member 223 on base 216 and more than one fastening member 205 adjacent to another fastening member 205 on inner surface 221 of container 201, then there may be more than one such engagements as described herein.

Chamber 231, as shown in FIGS. 8, 10(b), and 11, may generally comprise the shape of a hollow cylinder that is closed on one end. Thus, chamber 231 may comprise a first surface 232 representing the closed end, surface walls 233 representing the walls of the cylinder, and an open end 234. First surface 232 may be flat, or alternatively it may have a curved shape, such as a hemisphere or a portion of a hemisphere, or a rounded cone.

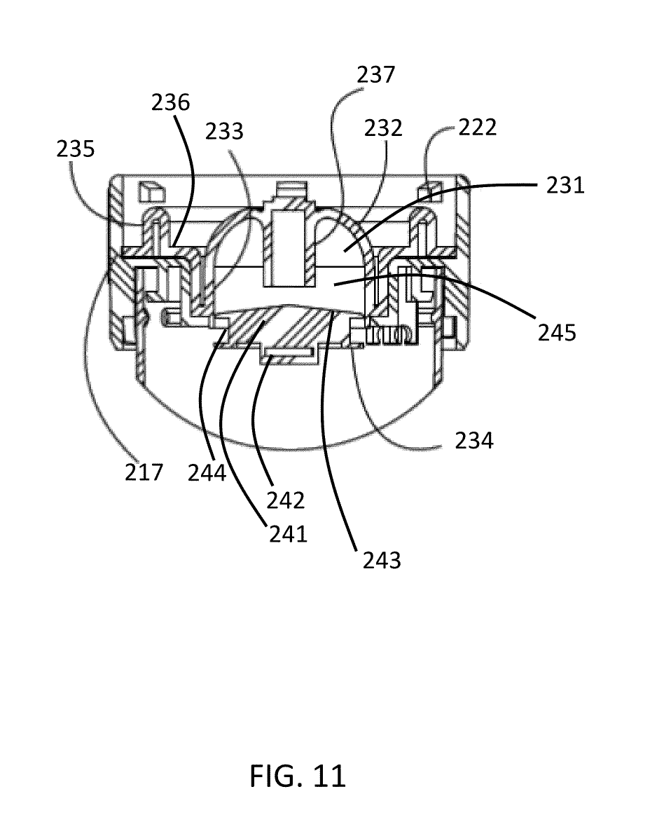

Chamber 231 may also comprise one or more outer rims 235 around its circumference. In certain embodiments, outer rim 235 may be separated by a small distance 236 from surface walls 233, as illustrated in FIG. 11. In some embodiments, when closure 211 is fastened to container 201 in orientation 2, outer rim 235 engages with ledge 204 of container 201 to create a seal.

As shown in FIG. 8, a portion of chamber 231 can fit into lumen 220 of inner skirt 218 of base 216. In some embodiments, chamber 231 and base 216 may comprise the same material and, in certain embodiments, may be manufactured in a single mold. In other embodiments, 231 chamber and base 216 are manufactured separately and are fit together, for example, as a snap fit, with an adhesive, etc.

First surface 232 of chamber 231 may include a structure or button 237, which may comprise a cylindrical shape or the like. Button 237 may move by manual pressure in the direction of open end 234 of chamber 231, and through open end 234. In some embodiments, there is an opening (not shown) on first surface 232 and pressure on button 237 in the direct of open end 234 will cause button 237 to move through the opening. In other embodiments, button 237 is fixed to, or is a part of, first surface 232, and manual pressure in the direction of open end 234 will cause first surface 232, and in some instances surface walls 233, to deform.

Plug 241 may be generally cylindrical and can fit into open end 234 of chamber 231 to form an enclosed reservoir 245 in chamber 231. Reservoir 245 can store the disposal device material. Plug 241 comprises an outward surface 242, an inward surface 243, and walls therebetween 244, such that, when plug 241 is positioned in open end 234 of chamber 231, inward surface 243 faces reservoir 245. Plug 241 can stay fitted in position in open end 234 of chamber 231 by a friction fit, snap fit, or use of an adhesive. In some embodiments, walls 244 may comprise one or more ridges 246 that may help plug 241 stay in position in open end 234 of chamber 231. Surface features (not shown) around open end 234 may be structured to engage the one or more ridges 246 of walls 244 of plug 241.

Plug 241 may be removed from position as a result of manual pressure on button 237 in the direction of open end 234; the manual pressure results in contact between button 237 and inward surface 243 of plug 241, and further manual pressure can dislodge or in general displace plug 241 from open end 234. In some embodiments, button 237 may be connected or attached to plug 241, in which manual pressure on button 237 in the direction of open end 234 will cause plug 241 to displace from its fitted position in open end 234 of chamber 231.

Removable seal 251, when in place, extends across inner surface 221 of outer shell 217 of base 216. Removable seal 251 can prevent closure 211 from being fastened to container 201 in orientation 2 and/or plug 241 from being displaced from open end 234 of the chamber 231. Removable seal 251 may comprise a tab 252, which can be used to pull removable seal 251 from its position across inner surface 221 of outer shell 217. Once removable seal 251 is removed, closure 211 can be fastened to container 201 in orientation 2 and/or plug 241 can be displaced from open end 234 of chamber 231.

Closure 211 as depicted in FIGS. 8-11 can be used to render medicaments stored in container 201 unusable by exposing the medicaments to disposal device material stored within reservoir 245 of chamber 231. This can be performed by removing removable seal 251 from inner surface 221 of outer shell 217 of base 216, and fastening closure 211 in orientation 2 to open end 202 of container 201. The fastening may lock closure 211 to container 201, such that closure 211 may be irremovable from container 201. Once fastened, manual pressure applied to button 237 on chamber 231 in the direction of open end 234, which is also in the direction of the container 201, may displace plug 241 from open end 234 of chamber 231, allowing the disposal device material that was stored in reservoir 245 of chamber 231 to disperse onto the medicament in container 201.

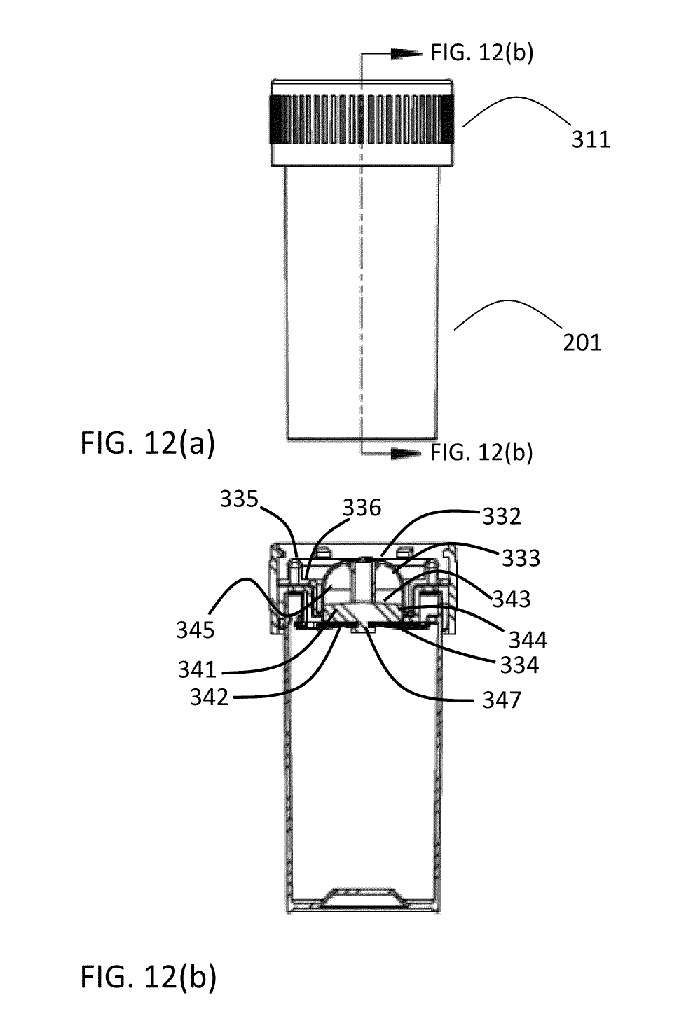

FIGS. 12(a)-(b) and 13 show alternative embodiments of the invention, in which closure 311 comprises a chamber 331 and plug 341 that are different as compared to chamber 231 and plug 241 of closure 211 shown in FIGS. 8-11. Further, chamber 231 may comprise an arm array 361 that is used to release the disposal device material for exposure to the medicament.

In these embodiments, chamber 331 may generally have the shape of a hollow cylinder that is closed on one end, thereby comprising a first surface 332 representing the closed end, surface walls 333 representing the walls of the cylinder, and an open end 334. First surface 332 may be flat, or alternatively it may have a curved shape, such as a hemisphere or a portion of a hemisphere, or a rounded cone. Chamber 331 may also comprise one or more outer rims 335 around its circumference. In certain embodiments, outer rim 335 may be separated by a small distance 336 from surface walls 333, as illustrated in FIG. 12(b). In some embodiments, when closure 311 is fastened to container 201 in orientation 2, outer rim 335 engages with ledge 204 of container 201 to create a seal.

As shown in FIG. 12(b), a portion of chamber 331 can fit into lumen 220 of inner skirt 218 of base 216. In some embodiments, chamber 331 and base 216 may comprise the same material and, in certain embodiments, may be manufactured in a single mold. In other embodiments, 331 chamber and base 216 are manufactured separately and are fit together, for example, as a snap fit, with an adhesive, etc.

Unlike chamber 231 depicted in FIGS. 8-11, chamber 331 does not comprise a button. Plug 341 may be generally cylindrical and can fit into open end 334 of chamber 331 to form a reservoir 345 in chamber 331 that can store the disposal device material. Plug 341 comprises an outward surface 342, an inward surface 343, and walls therebetween 344, such that, when plug 341 is positioned in open end 334 of chamber 331, inward surface 343 faces reservoir 345. Plug 341 can stay fitted in position in open end 334 of chamber 331 by a friction fit, by use of an adhesive, etc. In some embodiments, walls 344 may comprise one or more ridges 346 that may help plug 341 stay in position in open end 334 of chamber 331. Surface features (not shown) around open end 334 may be structured to engage the one or more ridges 346 of walls 344 of plug 341. Further, outward surface 342 of plug 341 may comprise an attachment 347 to which arm array 361 can fasten.

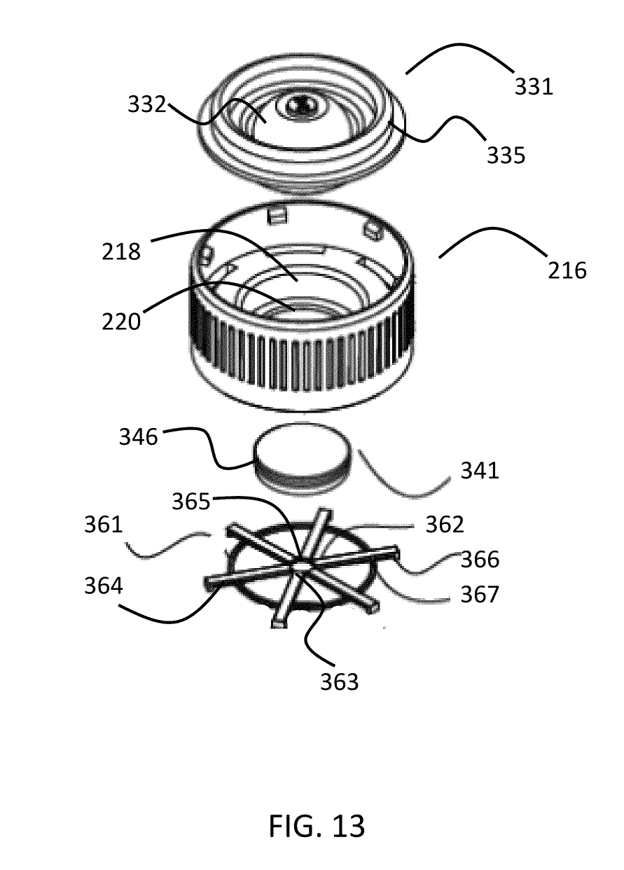

As shown in FIG. 13, arm array 361 may comprise two or more plug pulling arms 362 radiating from a circular center 365. Circular center 365 may be used to fasten arm array 361 to attachment 347 on outward surface 342 of plug 341, such as by a snap-fit. Each plug pulling arm 362 may comprise a center end 363 and an outer end 364. Outer end 364 may comprise a catch hook 366. The diameter of arm array 361 may be such that it fits inside open end 202 of container 201.

Plug pulling arms 362 may be attached to each other via a pivot ring 367, which is preferably attached to each plug pulling arm 362 at the same position, i.e., same distance from the respective center ends 363 of each plug pulling arm 362. For each plug pulling arm 362, pivot ring 367 may function as a fulcrum, such that movement of outer ends 364 in one direction results in displacement of center ends 363 in the opposite direction.

To neutralize or render medicament inside container 201 unusable, closure 311 may be fastened in orientation 2 to open end 202 of container 201. When the fastening is initiated, catch hooks 366 on outer ends 364 of plug pulling arms 362 may contact ledges 204 of container 201.

As fastening is completed, the engagement between catch hooks 366 and ledges 204 may cause outer ends 364 to move in a direction towards chamber 331 and, due to pivot ring 367 acting as a fulcrum, causes circular center 365 to move in a direction away from chamber 331. Since circular center 365 may be fastened to plug 341 through attachment 347, the movement of circular center 365 away from chamber 331 causes displacement of plug 341 from open end 334 of chamber 331. As a result, disposal device material stored in reservoir 345 can disperse onto the medicament in container 201. Therefore, unlike the embodiments of the invention depicted in FIGS. 8-11, the very act of fastening closure 311 to container 201 will expose medicament stored in container 201 to the disposal device material.

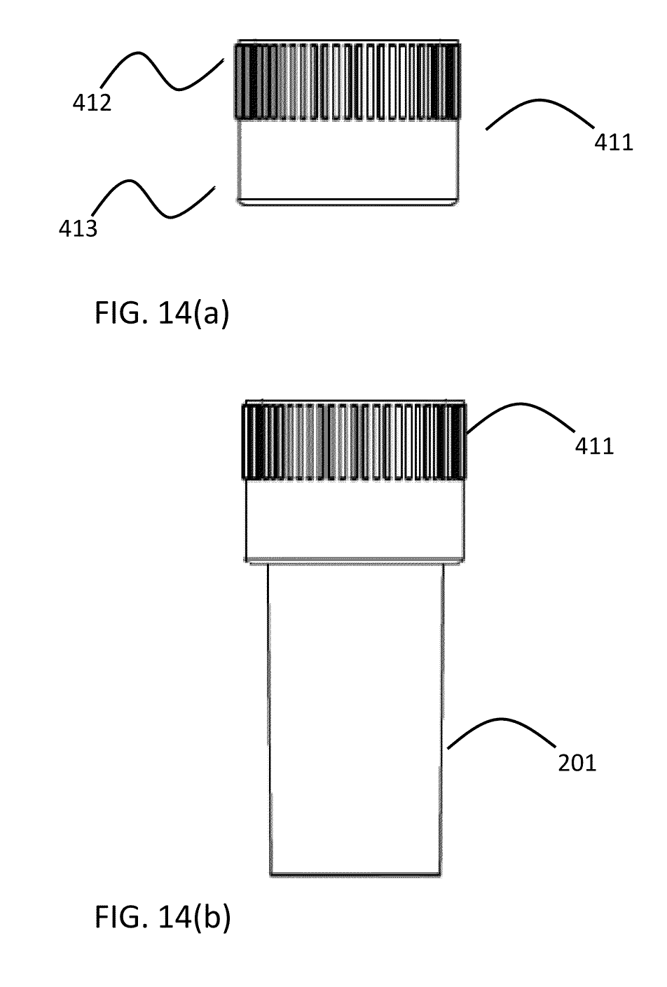

FIGS. 14-21 illustrate further embodiments of the invention in which the medicament disposal device is a medicament closure. In these embodiments, a lever 461 may be used to release the disposal device material for exposure to the medicament.

Closure 411 comprises a first end 412 and a second end 413, and can be used with medicament containers that are known in the art, including container 201 described herein.

As shown in FIGS. 14(a)-(b) and 15(a)-(b), closure 411 can be fastened to container 201 in two orientations. Orientation 1, shown in FIGS. 14(a)-(b), is used to close container 201 while the medicament is still being administered according to its intended use, i.e., prior to disposing the medicament. In orientation 1, second end 413 of closure 411 is removably fastened to the container 201. In some embodiments, second end 413 of closure 411 may comprise a child-resistant lock, as known in the art.

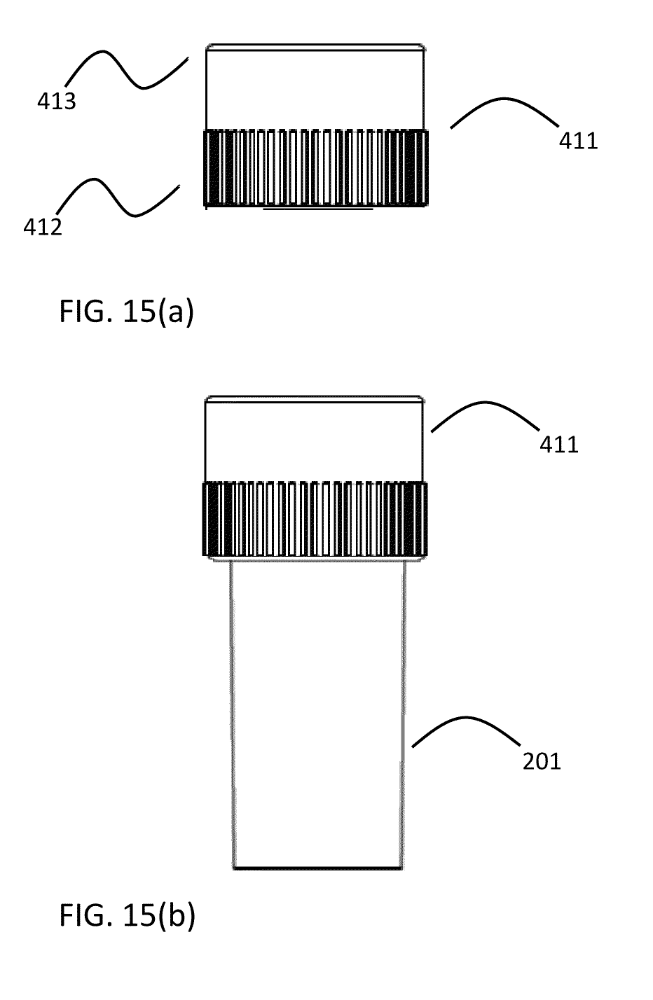

Orientation 2, as shown in FIGS. 15(a)-(b), is used to close the container for disposing of the medicaments. In orientation 2, first end 412 of closure 411 is irremovably fastened to the container 201.

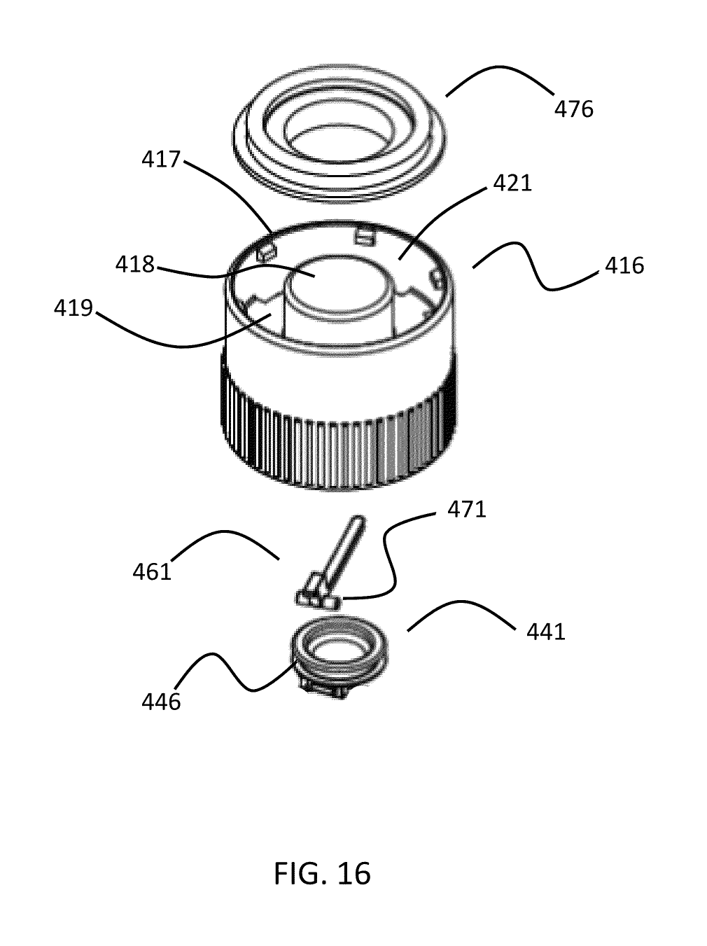

FIG. 16 shows an exploded view of closure 411 in orientation 2. Closure 411 may comprise a base 416, a plug 441, optionally a removable seal (not shown), and a set seal 476. Base 416 may comprise an outer shell 417, a chamber 418, and one or more inner rims 419 that connect outer shell 417 and chamber 418. In certain embodiments, outer shell 417 and chamber 418 are cylindrical and concentric.

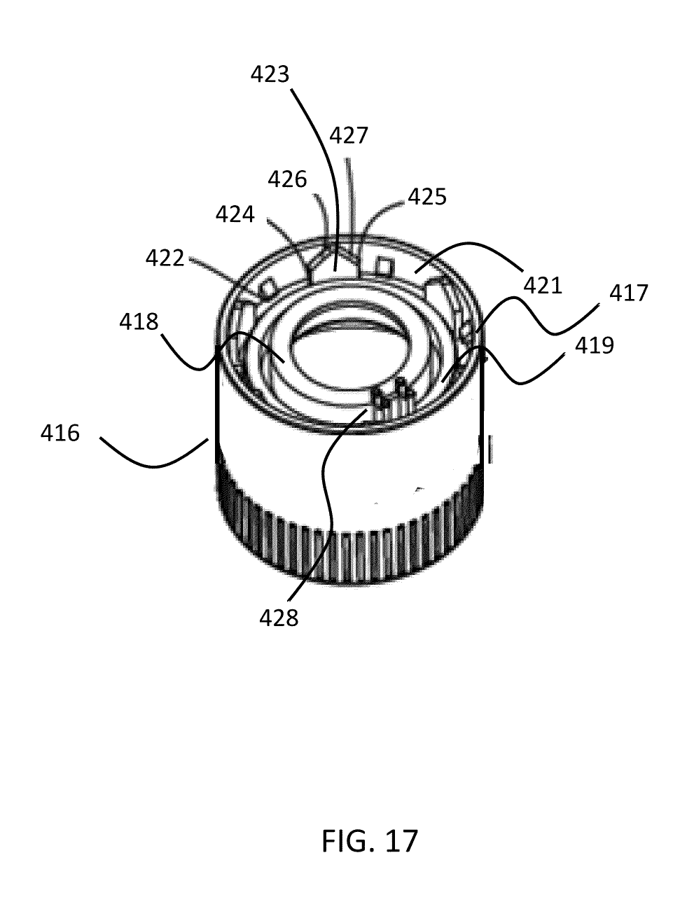

As shown in FIG. 17, the inner surface 421 of outer shell 417 may comprise structures as described above that enable closure 411 to be irremovably fastened to container 201. These include one or more pawls 422 and/or one or more angled members 423. Angled members 423 may comprise one or more angled surfaces, and in some embodiments, may comprise two angled surfaces that meet at a corner. In certain embodiments, the angled members may resemble a hexagon with a first straight surface 424 and a second straight surface 425, and a first angled surface 426 and a second angled surface 427. In addition, inner surface 421 may comprise a lever arm holder 428, which may comprise two members having a U-shaped or O-shaped end into which a cylindrical structure can fit.

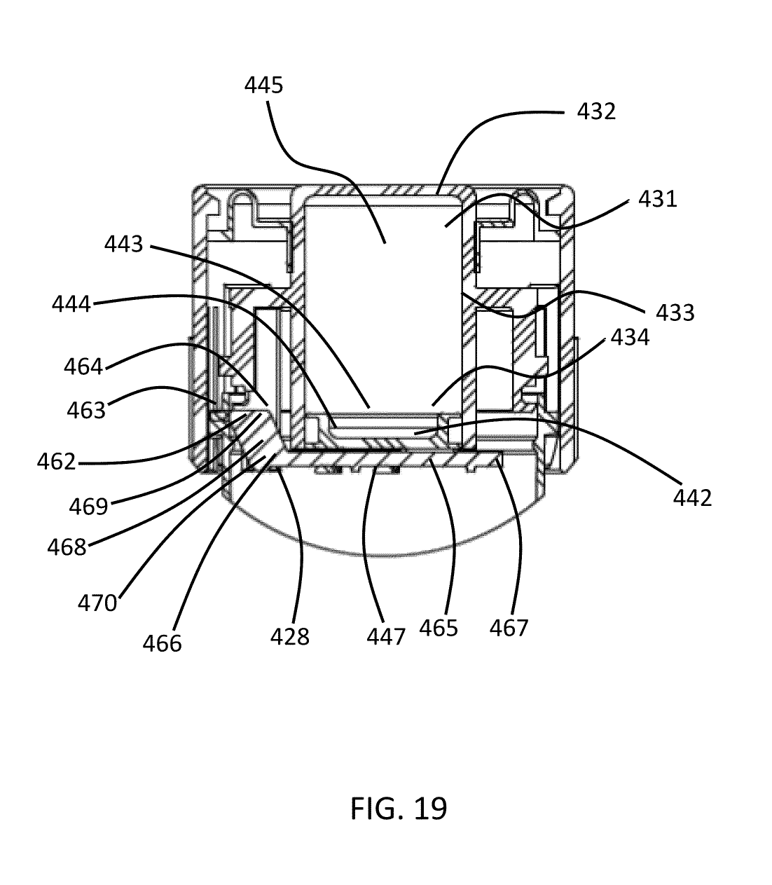

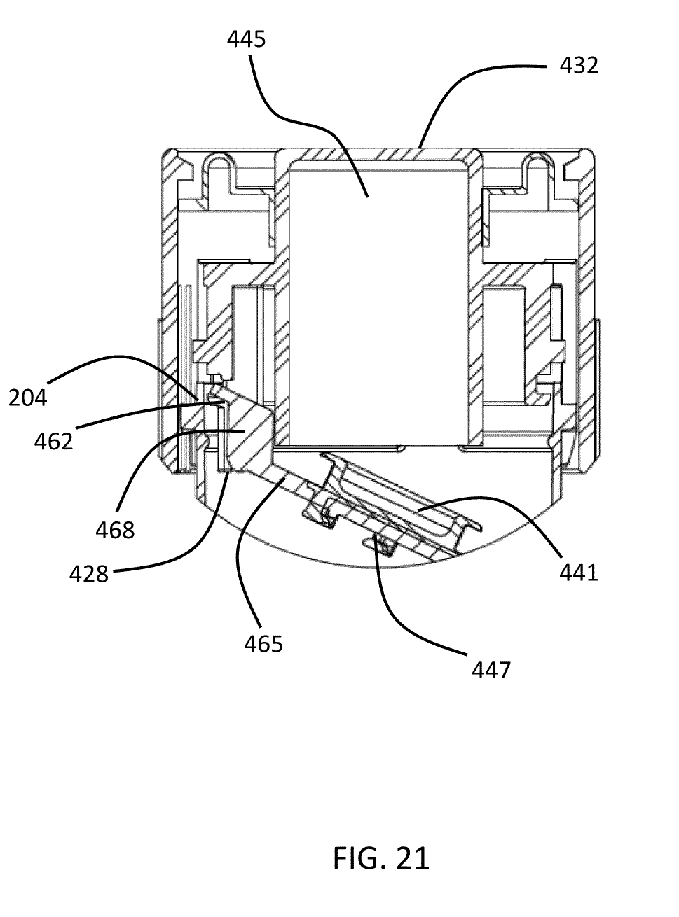

Chamber 431, as shown in FIGS. 19 and 21, may generally comprise the shape of a hollow cylinder that is closed on one end. Thus, chamber 431 may comprise a first surface 432 representing the closed end, surface walls 433 representing the walls of the cylinder, and an open end 434. First surface 432 may be flat, or alternatively it may have a curved shape, such as a hemisphere or a portion of a hemisphere, or a rounded cone.

Plug 441 may be generally cylindrical and can fit into open end 434 of chamber 431 to form a reservoir 445 in chamber 431 that can store the disposal device material. Plug 441 comprises an outward surface 442, an inward surface 443, and walls therebetween 444, such that, when plug 441 is positioned in open end 434 of chamber 431, inward surface 443 faces reservoir 445. Plug 441 can stay fitted in position in open end 234 of chamber 231 by a friction fit, by use of an adhesive, etc. In some embodiments, walls 444 may comprise one or more ridges 446 that may help plug 441 stay in position in open end 434 of chamber 431. Surface features (not shown) around open end 434 may be structured to engage the one or more ridges 446 of walls 444 of plug 441. Further, outward surface 442 of plug 441 may comprise an attachment 447 to which a lever 461 can fasten.

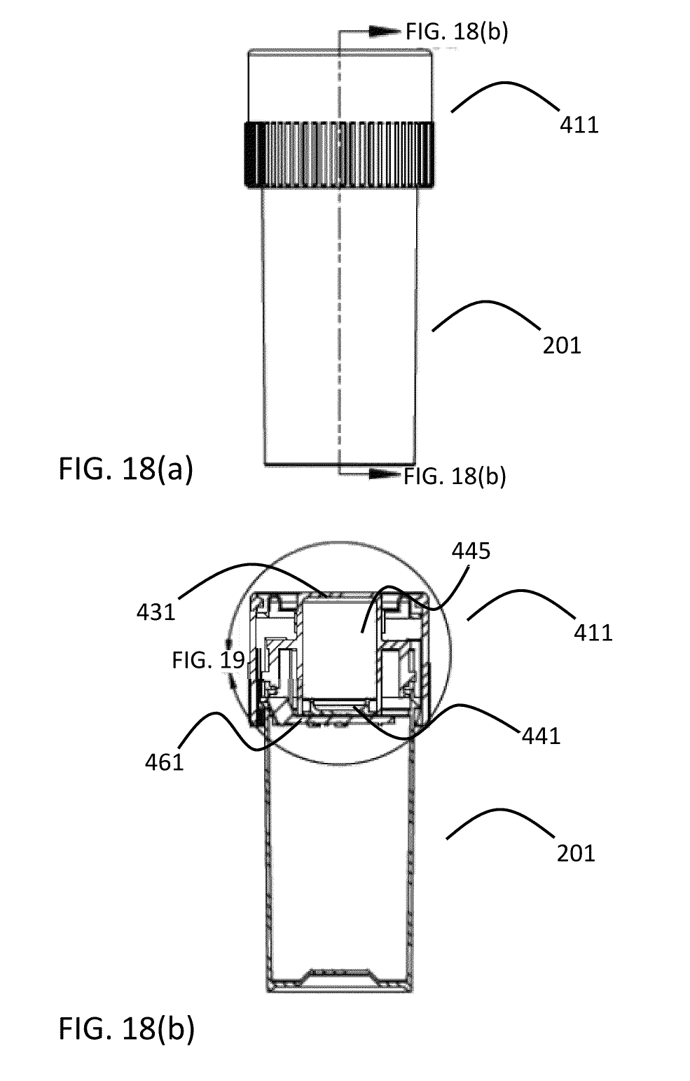

As shown in FIGS. 18(b), 19, 20(b), and 21, lever 461 may resemble the shape of a “Z,” comprising a ledge arm 462 (the top horizontal line of the “Z”) having a first end 463 and a second end 464, an attachment arm 465 (the bottom horizontal line of the “Z”) having a first end 466 and a second end 467, and a connecting arm 468 (the diagonal line of the “Z”) having a first end 469 and a second end 470. Second end 464 of ledge arm 462 can be adjacent to first end 469 of connecting arm 468, and first end 466 of attachment arm 465 can be adjacent to second end 470 of connecting arm 468. The angle between ledge arm 462 and connecting arm 468 may be acute, obtuse or a right angle. Similarly, the angle between attachment arm 465 and connecting arm 468 may be acute, obtuse or a right angle. In preferred embodiments, both the angle between ledge arm 462 and connecting arm 468 and the angle between attachment arm 465 and connecting arm 468 are obtuse.

Lever 461 may comprise a cylindrical structure 471 at or near the junction between attachment arm 465 and connecting arm 468. Cylindrical structure 471 may be in a direction perpendicular to the long axis of attachment arm 465 and connecting arm 468, and can be used to connect lever 461 to lever arm holder 428 on inner surface 421 of outer shell 417. In some embodiments, cylindrical structure 471 fits inside the U-shaped or O-shaped ends of lever arm holder 428, and allows lever 461 to pivot at or near the junction of attachment arm 465 and connecting arm 468.

Attachment arm 465 is fastened to attachment 447 on outward surface 442 of plug 441. The length of the arms of lever 361 is such that it allows second end 467 of attachment arm 465 to be fastened to attachment 447 of plug 441, as well as allow first end 463 of ledge arm 462 to be adjacent to inner surface 421 of outer shell 417.

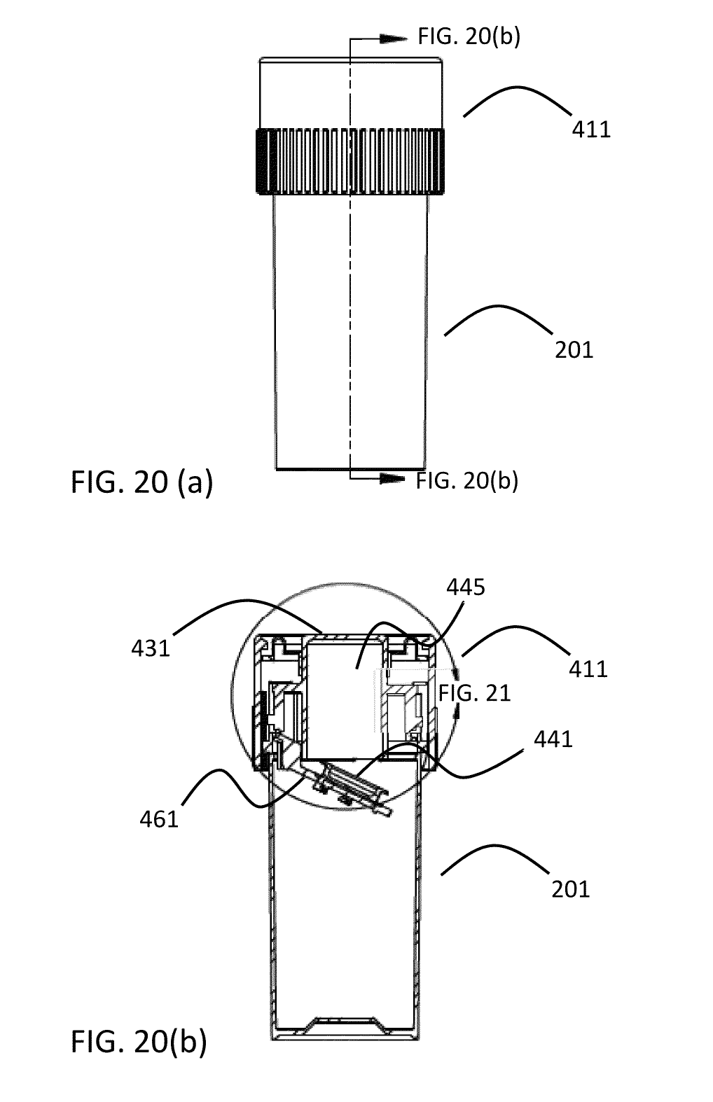

To neutralize or render medicament inside container 201 unusable, closure 411 is fastened in orientation 2 to open end 202 of container 201. When the fastening is initiated, as shown in FIGS. 18-19, first end 463 of ledge arm 462 contacts ledge 204 of container 201. When fastening is complete, as shown in FIGS. 20-21, the engagement of first end 463 on ledge 204 causes lever 461 to pivot at or near the junction of attachment arm 465 and connecting arm 468, which causes second end 467 of attachment arm 465 to move away from chamber 431. Since second end 467 of attachment arm 465 is fastened to plug 441 through attachment 447, the movement of second end 467 away from chamber 431 causes the displacement of plug 441 from open end 434 of chamber 431. As a result, disposal device material stored in reservoir 445 can disperse onto the medicament in container 201. Therefore, like the embodiments of the invention depicted in FIGS. 12-13, the act of fastening closure 411 to container 201 will expose medicament stored in container 201 to the disposal device material. The length of connecting arm 468 can influence when during the act of fastening closure 411 to container 201 the displacement of second end 467 of attachment arm 465 away from chamber 431 occurs. For example, if connecting arm 468 is longer, displacement of second end 467 will occur later in the act of fastening closure 411 to container 201. If connecting arm 468 is shorter, displacement of second end 467 will occur earlier during the act of fastening closure 411 to container 201.

In some embodiments, closure 411 may also comprise a removable seal (not shown) that extends across inner surface 421 of outer shell 417 of base 416. The removable seal prevents closure 411 from being fastened to container 201 in orientation 2 and/or prevents plug 441 from being displaced from open end 434 of the chamber 431. The removable seal may comprise a tab, which can be used to pull the removable seal from its position across inner surface 421 of outer shell 417 prior to fastening closure 411 to container 201. Once the removable seal is removed, closure 411 can be fastened to container 201 in orientation 2 and/or plug 441 can be displaced from open end 434 of chamber 431.

In general, closures of the present invention may comprise a moldable and rigid material. Examples include, but are not limited to polyethylene, high-density polyethylene, and polypropylene.

Plugs of the present invention may comprise a softer material than the closures, for example, rubbers, silicones, or thermoplastic polyurethanes. In some embodiments, the plugs may comprise a more rigid material, and an O-ring may be used to create a seal between the plugs and the open ends of the chambers.

Removable seals of the present invention may comprise a foil, paper, thin film made of a polymer, or the like. Removable seals may stay in its position across inner surfaces of outer shells due to an adhesive, friction-fit, etc.

Arm array 361 and lever 461 may comprise polyethylene, high-density polyethylene, or other rigid plastics or metals known in the art.

While specific embodiments of the subject invention have been discussed, the above specification is illustrative and not restrictive. One skilled in the art will appreciate that numerous changes and modifications can be made to the invention, and that such changes and modifications can be made without departing from the spirit and scope of the invention. The full scope of the invention should be determined by reference to the claims, along with their full scope of equivalents, and the specification, along with such variations.

What is claimed is:

1. A device for the neutralization and disposal of unused medicaments, said device comprising a cylindrical container comprising walls, an open end, and a closed end located opposite to the open end, wherein:
the closed end comprises a reservoir that is separated from the inside of the cylindrical container by a barrier that traverses the cross-section of the cylindrical container, wherein the reservoir is enclosed by the barrier and a circular disc located opposite to the barrier that traverses the cross-section of the cylindrical container;
the barrier comprises a removable portion;
the circular disc comprises an oblong component that extends into the reservoir;
the circular disc is movable and is positioned such that manual pressure on the circular disc in a direction towards the barrier places the oblong component in contact with the removable portion of the barrier.

2. The device of claim 1, wherein the reservoir comprises a volume for housing a deactivating material in the form of powder, pellets, beads, beadlets, liquid, or granules.

3. The device of claim 1, wherein the circular disc or a portion thereof is positioned such that pressure on the circular disc in a direction towards the barrier places the oblong component in contact with the removable portion of the barrier.

4. The device of claim 3, wherein the circular disc or a portion thereof is positioned such that pressure on the circular disc in a direction towards the barrier displaces the removable portion from the barrier.

5. The device of claim 1, wherein the oblong component comprises an end having a shape that fits into the surface of the removable portion of the barrier.

6. The device of claim 1, wherein the oblong component comprises a multitude of ribs.

7. The cylindrical container of claim 1, wherein the oblong component is molded as part of the circular disc.

8. The device of claim 1, wherein the removable portion of the barrier is divided into two or more segments.

9. The device of claim 8, wherein the removable portion comprises a flexible thinned region that acts as a living hinge to allow the segments of the removable section to move while remaining attached to the barrier.

10. The device of claim 8, wherein the segments of the removable portion can separate and become displaced from the barrier.

11. The device of claim 1, further comprising a removable seal positioned under the circular disc.

12. The device of claim 11, wherein the removable seal comprises an annular thin section.

13. A device for the neutralization and disposal of unused medicaments, said device comprising a closure for a container, said closure comprising
(a) a base comprising a cylindrical structure with a first end and a second end, wherein both the first end and the second end can fasten onto the container; and
(b) a chamber comprising a cylindrical structure with a closed end, an open end, and surface walls extending there between, wherein:
(i) the chamber is located inside of the cylindrical structure of the base, and at least a portion of the surface walls of the chamber is attached to the cylindrical structure;
(ii) the open end of the chamber comprises a removable plug;
(iii) a structure in the chamber extends from the closed end of the chamber to the removable plug and is positioned such that manual pressure on the closed end towards removable plug causes the removable portion to move in a direction away from the closed end;
wherein the first end of the base is adjacent to the closed end of the chamber, and the second end of the base is adjacent to the open end of the chamber.

14. The device of claim 13, wherein the first end and the second end of the base comprises one or more annular grooves.

15. The device of claim 13, wherein the first end of the base comprises a child-resistant lock.

16. The device of claim 13, wherein the second end of the base can be irremovably fastened to the container.

17. The device of claim 13, wherein the chamber further comprises a reservoir for housing a material in the form of powder, pellets, beads, beadlets, liquid or granules.

18. The device of claim 13, wherein the removable plug can be displaced fully from the open end of the chamber.

19. The device of claim 13, further comprising a removable seal adjacent to the open end of the chamber.

20. A device for the neutralization and disposal of unused medicaments, said device comprising a closure for a container, said closure comprising (a) a base comprising a cylindrical structure with a first end and a second end and walls therebetween, wherein both the first end and the second end can fasten onto the container; and
(b) a chamber comprising a cylindrical structure with a closed end, an open end, and surface walls extending therebetween, wherein:
(i) the chamber is located inside of the cylindrical structure of the base, and at least a portion of the surface walls of the chamber is attached to the cylindrical structure;
(ii) the open end of the chamber comprises a removable plug; and
(c) a means of displacing the removable plug from the open end of the chamber, wherein the means comprises a first aspect that is adjacent to the wall of the base and a second aspect that is attached to the removable plug of the open end;
wherein the first end of the base is adjacent to the closed end of the chamber, and the second end of the base is adjacent to the open end of the chamber.

21. The device of claim 20, wherein the first end and the second end of the base comprises one or more annular grooves.

22. The device of claim 20, wherein the first end of the base comprises a child-resistant lock.

23. The device of claim 20, wherein the second end of the base can be irremovably fastened to the container.

24. The device of claim 20, wherein the chamber further comprises a reservoir for housing a material in the form of powder, pellets, beads, beadlets, or granules.

25. The device of claim 20, wherein the removable portion can be displaced fully from the second surface.

26. The device of claim 20, further comprising a removable seal adjacent to the open end of the chamber.

27. The device of claim 20, wherein fastening the second end of the base to the container causes the means of displacing the removable plug from the open end of the chamber to displace the removable plug.

28. The device of claim 27, wherein fastening the second end of the base to the container causes the first aspect of the means of displacing the removable plug from the open end of the chamber to displace in the opposite direction of the displacement of the removable plug.

29. The device of claim 20, wherein the means of displacing the removable plug from the open end of the chamber comprises an arm array, wherein the arm array comprises two or more arms radiating from a center, and wherein the arms extend to the wall of the base and the center is attached to the removable plug.

30. The device of claim 20, wherein the means of displacing the removable plug from the open end of the chamber comprises a lever, wherein the lever comprises a first end and a second end, and wherein the first end of the lever is adjacent to the wall of the base and the second end of the lever is attached to the removable plug.
